(19) United States
(12) Patent Application Publication
(10) Pub. No.: US 2009/0236543 A1
(43) Pub. Date: Sep. 24, 2009

(54) Fluorescence Detection Using Lyman-alpha Line Illumination

(75) Inventors: Hiroshi Ooki, Tokyo (JP); W. Thomas Novak, Hillsborough, CA (US)

Correspondence Address: LAWRENCE R. OREMLAND, P.C., 5055 E. BROADWAY BLVD., SUITE C-214, TUCSON, AZ, 85711, US

(73) Assignee: Nikon Corporation, Tokyo (JP)

(21) Appl. No.: 12/406,000

(22) Filed: Mar. 17, 2009

Related U.S. Application Data
(60) Provisional application No. 61/038,025, filed on Mar. 19, 2008.

(51) Int. Cl. G01N 21/64

(52) U.S. Cl. 250/459.1; 250/461.1; 250/216

(57) ABSTRACT

A method and system is provided that takes advantage of the atmospheric transmission properties of the Hydrogen Lyman-α radiation line (121.6 nm wavelength) to illuminate a sample with high energy VUV photons at least partially in an atmospheric environment. Thus, according to the principles of the present invention, a sample is illuminated by radiation at the Hydrogen Lyman-α radiation line (121.6 nm wavelength), at least partially in an atmospheric environment, and luminescent radiation from the sample at longer wavelengths is detected. The high energy illuminating photons generate luminescent radiation from the sample at longer wavelengths, typically in the visible wavelength range, and this radiation can then be imaged, e.g. with a normal visible microscope.

### RELATED APPLICATION/CLAIM OF PRIORITY

This application is related to and claims priority from provisional application Ser. No. 61/038,025, filed Mar. 19, 2008, which provisional application is incorporated by reference herein.

### BACKGROUND

The Hydrogen Lyman-α radiation line light at the wavelength of 121.6 nm is normally considered to be within the VUV (vacuum ultra-violet) band. However, the present invention is based on the recognition that this wavelength is particularly convenient for optical applications because it has substantial atmospheric transmission.

### SUMMARY OF THE PRESENT INVENTION

The present invention takes advantage of the atmospheric transmission properties of the Hydrogen Lyman-α radiation line (121.6 nm wavelength) to illuminate a sample with high energy VUV photons at least partially in an atmospheric environment (without the need for a vacuum environment). The high energy illuminating photons generate luminescent radiation from the sample at longer wavelengths, typically in the visible wavelength range, and this radiation can then be imaged, e.g. with a normal visible microscope.

Other features of the present invention will be apparent from the following detailed description and the accompanying drawings

### BRIEF DESCRIPTION OF THE FIGURES

FIGS. 1a and 1b schematically illustrate two exemplary ways to illuminating a sample with high energy UV photons in an atmospheric environment, in accordance with the principles of the present invention.

### DETAILED DESCRIPTION

As described above, the present invention takes advantage of the atmospheric transmission properties of the Hydrogen Lyman-α radiation line (121.6 nm wavelength) to illuminate a sample with high energy VUV photons in an atmospheric environment (without the need for a vacuum environment). The high energy illuminating photons generate luminescent radiation from the sample at longer wavelengths, typically in the visible wavelength range, and this radiation can then be imaged with a normal visible microscope.

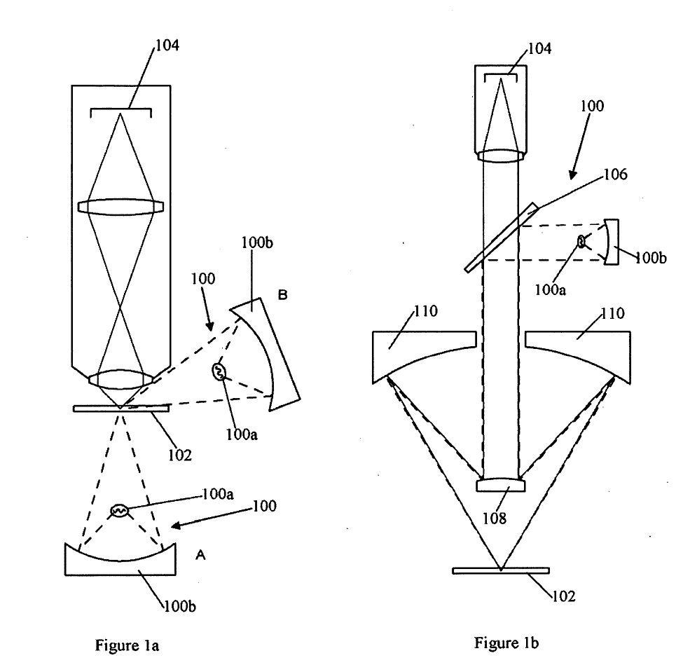

FIGS. 1a and 1b schematically illustrate three illumination conditions that apply the illumination principles of the present invention. In each of the figures, a source 100 generates light at the Hydrogen Lyman-α radiation line (121.6 nm wavelength), and that light is directed at a sample 102. Luminescent radiation from the sample 102 is then detected by a detector 104 which can be, e.g., part of a visible microscope.

In each of the figures, the source 100 comprises a lamp 100a or similar device that produces light at the Hydrogen Lyman-α radiation line (121.6 nm wavelength) and a concave reflector 100b, which reflects the Lyman-α radiation that is directed at the sample. Preferably, the source (i.e. lamp 100a and concave mirror 100b in FIG. 1a, and lamp 100a and optical components of a catadioptric optical system described further below) may be disposed in an atmosphere that is substantially free of oxygen, so that the oxygen does not interfere with the desired transmission of Lyman-α radiation at the sample 102. Moreover, in all of the disclosed embodiments, Lyman-α radiation from the source 100 is directed at the sample at least partially in an atmospheric environment, as further described below.

FIG. 1a illustrates two illumination conditions for illuminating the sample 102 with light at the Hydrogen Lyman-α radiation line (121.6 nm wavelength). In one illumination condition, light from the source 100 illuminates the sample 102 with Lyman-α radiation reflected from concave mirror 100b from the mirror orientation labeled A. The illumination of the sample from that orientation is sometimes referred to as “bright field” illumination, because light from the source at the Lyman-α radiation line is from an orientation that is substantially in line with the detector 104 that is part of the microscope that detects luminescent radiation from the sample. Moreover, in accordance with the principles of the present invention, at least a portion of the transmission of Lyman-α radiation is in an atmospheric environment (i.e. not in a vacuum environment). Thus, in the “bright line” illumination condition of FIG. 1a, the sample 102 is located in an environment that is completely exposed to atmosphere, and transmission of Lyman-α radiation directed from the source 100 at the sample is at least partially through that atmospheric environment. Thus, the transmission takes advantage of the ability to transmit Lyman-α radiation in an atmospheric environment, and by locating the sample in that atmospheric environment, the sample can be easily changed, without having to enter a chamber or other enclosure that controls the atmosphere in which the sample is located.

In another illumination condition illustrated in FIG. 1a, light from the source 100 illuminates the sample 102 with Lyman-α radiation reflected from concave mirror 100b from the mirror orientation labeled B. The illumination of the sample from that orientation is sometimes referred to as “dark field” illumination, because light from the source at the Lyman-α radiation line is from an orientation that is substantially oblique with respect to the cone of light directed into the optical system to the detector 104 that is part of the microscope that detects luminescent radiation from the sample. Thus, in the “dark field” illumination condition of FIG. 1a, the sample 102 is also located in an environment that is completely exposed to atmosphere, and transmission of Lyman-α radiation directed from the source 100 at the sample is at least partially through that atmospheric environment.

Accordingly, in each of the illumination conditions shown in FIG. 1a, the illumination of the sample 102, at the Lyman-α radiation line is at least partly in an atmospheric environment. Thus, the transmission takes advantage of the ability to transmit Lyman-α radiation in an atmospheric environment and by locating the sample in that atmospheric environment, the sample can be easily changed, without having to enter a chamber or other enclosure that controls the atmosphere in which the sample is located.

FIG. 1b illustrates a “bright field” environmental configuration where catadioptic imaging optics effectively form part of the source 100, and are shared by the illumination system, so that “bright field” illumination of the sample 102 is provided, at Lyman-α radiation line, at least partly in an atmospheric environment, and luminescent radiation from the sample 102 is detected by the detector 104 which can comprise, e.g. a part of a visible microscope. In the illumination system and method of FIG. 1b, the source of light at the Lyman-α radiation line is produced by a source that includes the lamp 100a, concave mirror 100b, and catadioptric optics comprising a beam splitter 106, a convex reflector 108, and one of a pair of concave mirrors 110. Luminescent radiation from the sample is reflected from one of the concave mirrors 110, the convex reflector 108 and is directed through beam splitter 106 and to the detector 104. The sample 102 is located in an atmospheric environment that encompasses at least part of the optical path between the mirrors 110 and the sample 102.

In all of the illustrated embodiments, the path of the Lyman-α radiation is shown with dashed line.

Although FIGS. 1a and 1b generally show the Lyman-α radiation directed with reflective optics, there are optical materials that could be used for transmissive elements. LiF and MgF₂ both have significant transmission at this wavelength, at least for thin elements like the beam splitter 106 shown in FIG. 1b, and possibly for small lens elements near the sample. Thus, while the “source” 100 shown in the figures comprises the lamp 100a and the concave mirror 100b, the source could also include a lamp and a transmissive element.

Although other applications of the Lyman-α line are known, and although fluorescence microscopy is also well known, the use of Lyman-α radiation for illumination in fluorescence microscopy, at least partially in an atmospheric environment, and according to the principles of the present invention, is new.

An advantage of this invention is that using illumination with such a short wavelength (121.6 nm) should expand the range of fluorophores that can be excited and imaged. This is conveniently enabled by the choice of wavelength, since the radiation can be readily generated with a Hydrogen Lyman-α source, and since this atmosphere is relatively transmissive at this wavelength.

Furthermore, since the imaging optics do not have to transmit the illuminating radiation, this invention could be embodied as an attachment to an existing visible microscope, provided that the fluorescent wavelength is within the transmission bandwidth of the optics. For example, the principles of the present invention can be used with a microscope such as shown in U.S. Pat. No. 6,337,767, which is assigned to the assignee of the present invention, and incorporated herein by reference. The microscope disclosed in that patent is configured to detect both radiation in the visible range, and also radiation in the ultraviolet range. Thus, if luminescence from the sample, produced according to the principles of the present invention, is in the visible range, that luminescence can be detected by the microscope in its visible detection mode. On the other hand, if luminescence from the sample is in the ultraviolet range (especially the near ultraviolet range), that luminescence can also be detected by the microscope in its ultraviolet mode.

Accordingly, the foregoing description illustrates and describes how the principles of the present invention provide for illuminating a sample by radiation at the Hydrogen Lyman-α radiation line (121.6 nm wavelength), at least partially in an atmospheric environment, and detecting luminescent radiation from the sample at longer wavelengths.

With the foregoing description in mind, the manner in which the principles of the present invention can be used to provide various systems and methods for illuminating a sample using the Hydrogen Lyman-α radiation line (121.6 nm wavelength) in an atmospheric environment will be apparent to those in the art.

1. An illumination/detection method comprising illuminating a sample with radiation at the Hydrogen Lyman-α line (121.6 nm wavelength), at least partially in an atmospheric environment, and detecting luminescent radiation from the sample at longer wavelengths.

2. The illumination/detection method of claim 1, wherein the source produces radiation at the Hydrogen Lyman-α line and transmission of the radiation from the source to the sample is at least partially in an atmospheric environment.

3. The illumination/detection method of claim 2, wherein illumination of the sample at the Hydrogen Lyman-α radiation line is from a source at an orientation that is substantially in line with a device that detects luminescent radiation from the sample.

4. The illumination/detection method of claim 2, wherein illumination of the sample at the Hydrogen Lyman-α radiation line is from a source at an orientation that is oblique with respect to a device that detects luminescent radiation from the sample.

5. The illumination/detection method of claim 2, wherein illumination of the sample at the Hydrogen Lyman-α radiation line is provided via catadioptic imaging optics that direct radiation from the source at the sample and also transmits luminescent radiation from the sample to a device that detects luminescent radiation from the sample.

6. The illumination/detection method of claim 1, wherein luminescent radiation from the sample at wavelengths in the visible wavelength range is detected with a visible microscope.

7. The illumination/detection method of claim 1, wherein illumination of the sample at the Hydrogen Lyman-α radiation line is from a source at an orientation that is substantially in line with a device that detects luminescent radiation from the sample.

8. The illumination/detection method of claim 1, wherein illumination of the sample at the Hydrogen Lyman-α radiation line is from a source at an orientation that is oblique with respect to a device that detects luminescent radiation from the sample.

9. The illumination/detection method of claim 1, wherein illumination of the sample at the Hydrogen Lyman-α radiation line is provided via catadioptic imaging optics that direct radiation from the source at the sample and also transmits luminescent radiation from the sample to a device that detects luminescent radiation from the sample.

10. An illumination/detection system comprising an optical illumination portion that illuminates a sample and an optical detection portion that detects luminescent radiation from the sample, wherein the optical illumination portion includes an illumination source at the Hydrogen Lyman-α radiation line (121.6 nm wavelength), and a transmission portion that directs illumination from the source at the sample at least partially in an atmospheric environment, and wherein the optical detection portion detects luminescent radiation from the sample at longer wavelengths.

11. The illumination/detection system of claim 10, wherein radiation transmission between the source and the sample is conducted at least partially in an atmospheric environment.

12. The illumination/detection system of claim 11, wherein the transmission portion directs the Hydrogen Lyman-α radiation at the sample from an orientation that is substantially in line with the optical detection portion.

13. The illumination/detection system of claim 11, wherein the transmission portion directs the Hydrogen Lyman-α radiation at the sample from an orientation that is substantially oblique with respect to the sample and to the optical detection portion.

14. The illumination/detection system of claim 11, wherein the transmission portion directs the Hydrogen Lyman-α radiation at the sample via catadioptic imaging optics that also transmits luminescent radiation from the sample to the optical detection portion.

15. The illumination/detection system of claim 10, wherein the optical detection portion includes a visible microscope.

16. The illumination/detection system of claim 10, wherein the transmission portion directs the Hydrogen Lyman-α radiation at the sample from an orientation that is substantially in line with the optical detection portion.

17. The illumination/detection system of claim 10, wherein the transmission portion directs the Hydrogen Lyman-α radiation at the sample from an orientation that is substantially oblique with respect to the sample and to the optical detection portion.

18. The illumination/detection system of claim 10, wherein the transmission portion directs the Hydrogen Lyman-α radiation at the sample via catadioptic imaging optics that also transmits luminescent radiation from the sample to the optical detection portion.
